(19) United States
(12) Patent Application Publication
(10) Pub. No.: US 2021/0058562 A1
(43) Pub. Date: Feb. 25, 2021

(54) ELECTRONIC APPARATUS, CONTROL METHOD OF ELECTRONIC APPARATUS, AND STORAGE MEDIUM

(71) Applicant: CANON KABUSHIKI KAISHA, Tokyo (JP)

(72) Inventor: Kazuomi Toguchi, Yokohama-shi (JP)

(21) Appl. No.: 16/994,320

(22) Filed: Aug. 14, 2020

(30) Foreign Application Priority Data
Aug. 21, 2019 (JP) 2019-151530

(51) Int. Cl. H04N 5/232; G06F 3/01

(52) U.S. Cl. CPC H04N 5/232939; G06F 3/013

(57) ABSTRACT

An electronic apparatus includes a line-of-sight detection unit that detects a viewed position on a display unit, a display control unit that displays a predetermined display item on the display unit in a case where the viewed position on an edge area of an image displayed on the display unit is detected, and a control unit that controls execution of processing corresponding to the display item in a case where a first predetermined condition is satisfied in a state where the viewed position on the display item is detected.

### BACKGROUND

### Field

The present disclosure relates to an electronic apparatus that is capable of detecting a line of sight, a control method of the electronic apparatus, and a storage medium.

### Description of the Related Art

There is known a technique of detecting the position at which a user's line of sight is directed and using a result of the detection.

Japanese Patent Application Laid-Open No. 2013-83731 discusses a head-mounted display (HMD) that starts image display in a display area if a user is looking at a display start area, based on an eye direction of the user and a turning angle of the head of the user. Japanese Patent Application Laid-Open No. 2015-223913 discusses a technique that detects a line of sight of a user and selects an icon corresponding to a gaze point.

In a case where an item is selected based on the position at which the line of sight of a user is directed, if display starts in response to detection of a state where the user is looking at a specific area as discussed in Japanese Patent Application Laid-Open No. 2013-83731, the user is likely to gaze at a newly displayed item. If an item is displayed beforehand as discussed in Japanese Patent Application Laid-Open No. 2015-223913, visibility is likely to decline for a user who intends to view an item or image different from the displayed item.

In view of the above, what is needed is an improvement in operability of a line-of-sight-based input operation without reducing visibility.

### SUMMARY

According to an aspect of the present invention, an electronic apparatus includes a line-of-sight detection unit configured to detect a viewed position on a display unit, a display control unit configured to display a predetermined display item on the display unit in a case where the viewed position on an edge area of an image displayed on the display unit is detected, and a control unit configured to control execution of processing corresponding to the display item in a case where a first predetermined condition is satisfied in a state where the viewed position on the display item is detected.

Further features will become apparent from the following description of exemplary embodiments with reference to the attached drawings.

### BRIEF DESCRIPTION I/F THE DRAWINGS

FIG. 1 is an external view of a digital camera.

FIG. 2 is an external view of the digital camera.

FIG. 3 is a block diagram illustrating a configuration of the digital camera.

FIG. 4 is a diagram illustrating an example of a screen with a line-of-sight-based input.

FIG. 5 is a diagram illustrating an example of a screen with a line-of-sight-based input on an edge area of a display screen.

FIG. 6 is a diagram illustrating an example of a screen in which a display item is gazed at.

FIG. 7 is a diagram illustrating an example of a screen after next-image-display processing is executed.

FIG. 8 is a diagram illustrating an example of a screen after display of a display item is canceled.

FIG. 9 is a flowchart illustrating processing which is executed by the digital camera.

### DESCRIPTION I/F THE EMBODIMENTS

An exemplary embodiment will be described below with reference to the accompanying drawings.

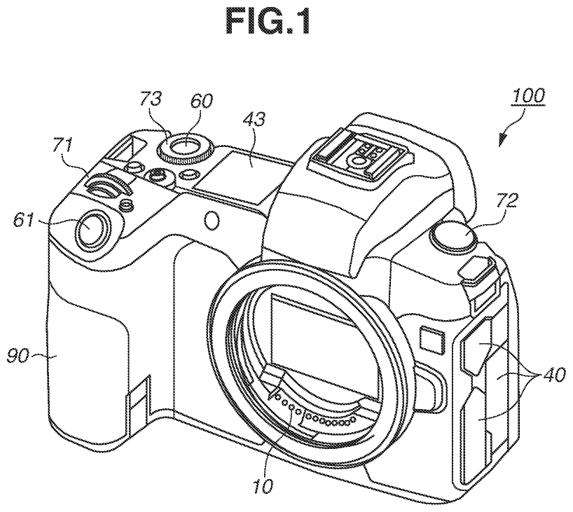

FIG. 1 is an external view of a digital camera 100 according to the present exemplary embodiment as viewed from the front. The digital camera 100 is an example of an electronic apparatus, and can capture a still image and a moving image.

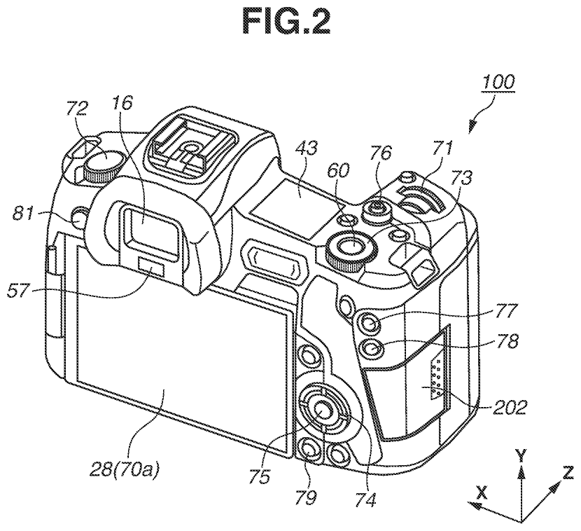

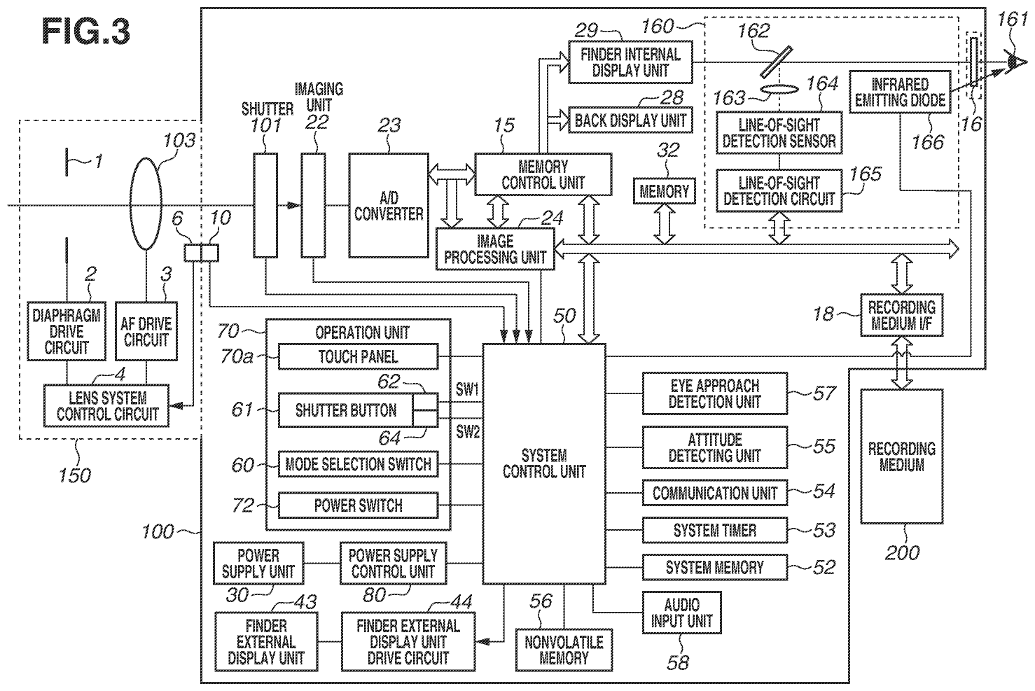

FIG. 2 is an external view of the digital camera 100 according to the present exemplary embodiment as viewed from the back. The digital camera 100 includes a mode selection switch 60, a shutter button 61, a main electronic dial 71, a power switch 72, an electronic sub-dial 73, a cross key 74, a SET button 75, a moving image button 76, an automatic exposure (AE) lock button 77, a zoom button 78, a playback button 79, and a menu button 81, as an operation unit 70 (see FIG. 3 to be described below). Input data from the operation unit 70 is output to a system control unit 50 (see FIG. 3 to be described below).

The mode selection switch 60 switches between various modes. The shutter button 61 provides an image capturing preparation instruction and an image capturing instruction. The main electronic dial 71 is a rotatable operation member, and, for example, changes setting values, such as a shutter speed and an aperture. The power switch 72 switches between ON and OFF of the power of the digital camera 100. The electronic sub-dial 73 is a rotatable operation member, and, for example, moves a selection frame and displays the next image. The cross key 74 (a four-direction key) includes upper, lower, right, and left portions that can each be pressed. An operation corresponding to the pressed portion is thereby enabled. The SET button 75 is a push button, and mainly used to determine a selected item.

The moving image button 76 provides an instruction to start or stop moving image capturing (recording). The AE lock button 77 is used to fix an exposure state. The zoom button 78 switches between ON and OFF of an expansion mode in live-view display in an image capturing mode. The playback button 79 switches between the image capturing mode and a playback mode. Pressing the playback button 79 in the image capturing mode causes the digital camera 100 to transition to the playback mode, and the latest image among images recorded in a recording medium 200 (see FIG. 3 to be described below) is displayed on a display unit. The menu button 81 is used to display a menu screen in which various settings can be made.

The digital camera 100 includes a back display unit 28, a finder external display unit 43, a finder internal display unit 29 (hereinafter referred to as “electronic view finder (EVF) 29”, see FIG. 3 to be described below), as the display unit.

The back display unit 28 includes a touch panel 70a having the function of the operation unit 70. The back display unit 28 is disposed on the back of the digital camera 100, and displays an image and various data under the control of the system control unit 50. The finder external display unit 43 is disposed on the top surface of the digital camera 100, and displays various setting values, such as a shutter speed and an aperture. The EVF 29 is configured of, for example, an organic electroluminescent (EL) display or a liquid crystal display (LCD), and disposed inside the digital camera 100. As with the back display unit 28, an image and various data are displayed under the control of the system control unit 50.

The digital camera 100 includes an eyepiece unit 16 and an eye approach detection unit 57.

The eyepiece unit 16 is an eyepiece viewfinder (a look-through type viewfinder). A user can visually recognize an image displayed on the EVF 29 via the eyepiece unit 16. The eye approach detection unit 57 is an eye approach detection sensor that detects the approach of an eye of the user to the eyepiece unit 16.

The digital camera 100 includes a grip portion 90 and a lid 202 disposed on the right side of the digital camera 100, and includes a terminal cover 40 disposed on the left side thereof.

The grip portion 90 is a holding portion having a shape that enables the user to easily grip the grip portion 90 with the right hand when holding the digital camera 100. The lid 202 closes a slot where the recording medium 200 is stored. The terminal cover 40 protects a connector (not illustrated) that connects a connection cable for connection to an external device and the digital camera 100. The digital camera 100 includes a communication terminal 10 (see FIG. 3 to be described below) for communicating with a lens unit 150 (see FIG. 3 to be described below) that is attachable to and detachable from the digital camera 100.

FIG. 3 is a block diagram illustrating a configuration of the digital camera 100 according to the present exemplary embodiment. Configurations identical to those in FIG. 1 and FIG. 2 are provided with the same reference numerals as those in FIG. 1 and FIG. 2, and the description thereof will be omitted where appropriate.

The lens unit 150 is attached to the digital camera 100. The lens unit 150 includes a lens 103, a diaphragm 1, a diaphragm drive circuit 2, an automatic focus (AF) drive circuit 3, a lens system control circuit 4, and a communication terminal 6.

The lens 103 typically includes a plurality of lenses, but here, the lens 103 is simplified and illustrated using only one lens. The lens system control circuit 4 communicates with the digital camera 100 via the communication terminal 6 and the above-described communication terminal 10. Further, the lens system control circuit 4 controls the diaphragm 1 via the diaphragm drive circuit 2. The lens system control circuit 4 achieves focus by displacing the lens 103 via the AF drive circuit 3.

The digital camera 100 includes a shutter 101, an imaging unit 22, an analog-to-digital (A/D) converter 23, an image processing unit 24, a memory control unit 15, and a memory 32.

The shutter 101 is a focal plane shutter that can freely control an exposure period of the imaging unit 22. The imaging unit 22 is an image sensor including a charge coupled device (CCD) sensor or a complementary metal oxide semiconductor (CMOS) sensor that converts an optical image into an electrical signal. The A/D converter 23 converts an analog signal output from the imaging unit 22 into a digital signal. The image processing unit 24 performs predetermined resizing processing such as pixel interpolation and reduction, and color conversion processing, on image data from the A/D converter 23 and the memory control unit 15.

The memory control unit 15 controls data transmission and reception between the A/D converter 23, the image processing unit 24, and the memory 32. The image data from the A/D converter 23 is written into the memory 32, via the image processing unit 24 and the memory control unit 15, or directly via the memory control unit 15. The memory 32 stores data, such as image data from the A/D converter 23. The memory 32 has a capacity sufficient for storing a predetermined number of still images and a moving image and sound for a predetermined time. The memory 32 also serves as a memory (a video memory) for image display.

The digital camera 100 includes the finder external display unit 43, a finder external display unit drive circuit 44, the system control unit 50, a nonvolatile memory 56, a system memory 52, an audio input unit 58, and a system timer 53.

The finder external display unit 43 is driven by the finder external display unit drive circuit 44 to display various setting values of the digital camera 100.

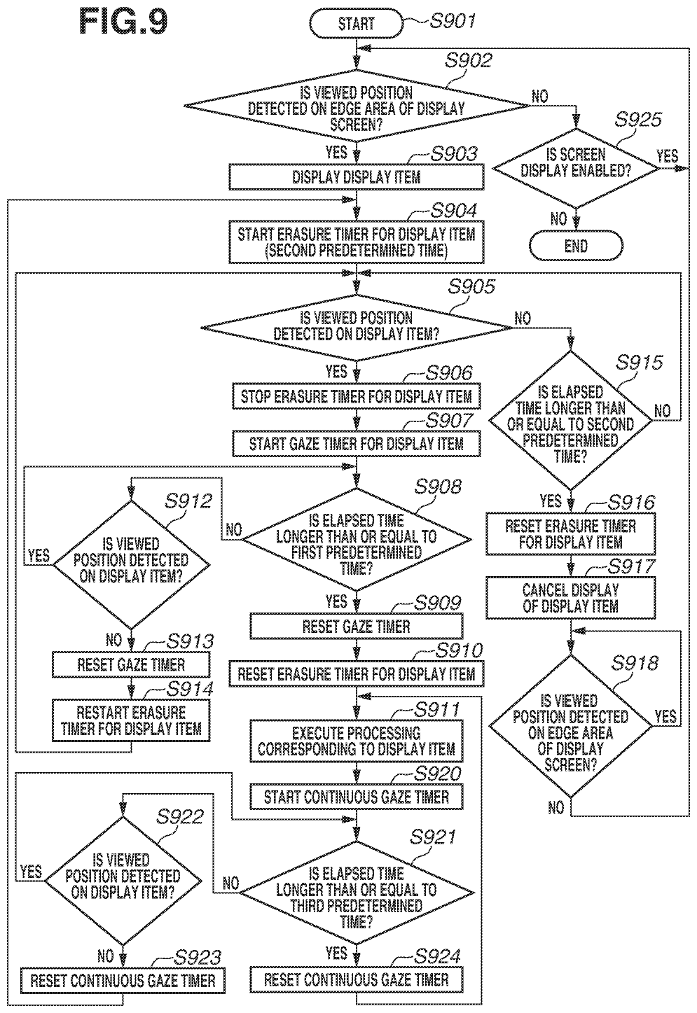

The system control unit 50 is at least one processor, or an arithmetic processing unit configured of a circuit, and controls the entire digital camera 100. The system control unit 50 controls each unit of the digital camera 100, by executing a program stored in the nonvolatile memory 56 to be described below, so that each step of a flowchart in FIG. 9 is implemented.

The nonvolatile memory 56 is an electrically erasable recordable memory, and is configured of a device such as a flash read-only memory (flash ROM). The nonvolatile memory 56 stores constants for operation of the system control unit 50, a program, and various items to be displayed on the back display unit 28 and the EVF 29. For example, a random access memory (RAM) is used for the system memory 52. Constants for operation of the system control unit 50, variables, and the program read out from the nonvolatile memory 56 are loaded into the system memory 52. The audio input unit 58 receives an audio input operation. The system timer 53 is a clocking unit that measures the time to be used for various types of control and the time of a built-in clock.

The digital camera 100 includes the shutter button 61, the mode selection switch 60, the power switch 72 described above, and the touch panel 70a, as the operation unit 70.

The shutter button 61 includes a first shutter switch 62 and a second shutter switch 64.

The first shutter switch 62 generates a first shutter switch signal SW1, by being turned on at a half press (an image capturing preparation instruction) of the shutter button 61. The system control unit 50 starts operation such as AF processing, AE processing, automatic white balance (AWB) processing, and electronic flash (EF) processing (pre-flash), based on the first shutter switch signal SW1.

The second shutter switch 64 generates a second shutter switch signal SW2, by being turned on at a full press (an image capturing instruction) of the shutter button 61. The system control unit 50 starts operation of a series of steps of image capturing processing from reading out a signal from the imaging unit 22 to writing image data about a captured image into the recording medium 200 as an image file, based on the second shutter switch signal SW2.

The mode selection switch 60 switches an operating mode of the system control unit 50 to any of modes including a still image capturing mode and a moving image capturing mode. The mode selection switch 60 enables the user to directly switch the operating mode to any mode. As a method for switching the operating mode, the following method can be adopted. First, the user switches to a list screen of the image capturing mode using the mode selection switch 60, and selects any of modes displayed in the list screen, and subsequently, the user switches to the selected mode using another member of the operation unit 70.

The touch panel 70a is integral with the back display unit 28.

For example, the touch panel 70a is configured to have a light transmittance that is not interfering with the display of the display unit 28, and is attached to the top layer of the display surface of the display unit 28. Position coordinates in the touch panel 70a and display coordinates on the display screen of the back display unit 28 are in correspondence with each other. This configures a graphical user interface (GUI) that makes the user feel as if the user can directly operate a screen displayed on the back display unit 28.

The system control unit 50 can detect the following operations or states on the touch panel 70a:
(1) a touch on the touch panel 70a by a finger or stylus pen not yet touching the touch panel 70a, i.e., a start of a touch (Touch-Down);
(2) a state where a finger or stylus pen is currently touching the touch panel 70a (Touch-On);
(3) an operation of moving a finger or stylus pen while maintaining the touch of the finger or stylus pen on the touch panel 70a (Touch-Move);
(4) an operation of removing a finger or stylus pen touching the touch panel 70a from the touch panel 70a, i.e., the end of a touch (Touch-Up); and
(5) a state where nothing touches the touch panel 70a (Touch-Off).

When Touch-Down is detected, Touch-On is simultaneously detected. After Touch-Down, Touch-On normally continues unless Touch-Up is detected. Detection of Touch-Move is also a state where Touch-On is being detected. Even if Touch-On is being detected, Touch-Move is not detected if there is no movement of a touch position. After all the fingers and pen that are touching are detected to be Touched-Up, Touch-Off is detected.

The above-described operations/states and the position coordinates of the finger or stylus pen currently touching on the touch panel 70a are notified to the system control unit 50 via an internal bus. The system control unit 50 determines what type of operation (touch operation) is performed on the touch panel 70a based on the notified information. As for Touch-Move, the system control unit 50 can determine a moving direction of the finger or stylus pen moving on the touch panel 70a, for each vertical component/horizontal component on the touch panel 70a, based on a change in the position coordinates. In a case where Touch-Move for a predetermined distance or more is detected, the system control unit 50 determines that a slide operation is performed. An operation of removing a finger after quickly moving the finger for some distance while maintaining the touch of the finger on the touch panel 70a is referred to as Flick. In other words, Flick is an operation of quickly running a finger on the touch panel 70a like flipping. If Touch-Move performed for a predetermined distance or more at a predetermined velocity or more is detected and then Touch-Up is detected, the system control unit 50 determines that Flick is performed (determines that Flick is performed subsequent to a slide operation). Further, a touch operation of simultaneously touching a plurality of points (e.g., two points) and then bringing the respective touch positions close to each other is referred to as Pinch-In, and a touch operation of moving the respective touch positions away from each other is referred to as Pinch-Out. Pinch-In and Pinch-Out are collectively referred to as the pinch operation (or simply as the pinch).

For the touch panel 70a, a touch panel of any of various types including a resistance film type, a capacitance type, a surface acoustic wave type, an infrared type, an electromagnetic induction type, an image recognition type, and an optical sensor type can be used. Depending on the type, a touch is detected based on the occurrence of contact with the touch panel 70a, or a touch is detected based on the occurrence of approach to the touch panel 70a, but either way can be adopted.

The digital camera 100 includes a power supply control unit 80, a power supply unit 30, a recording medium interface (I/F) 18, the recording medium 200, a communication unit 54, an orientation detecting unit 55, and the eye approach detection unit 57.

The power supply control unit 80 includes a battery detecting circuit, a direct current to direct current (DC-DC) converter, and a switch circuit for switching between blocks to be energized, and detects the presence or absence of attachment of a battery, the type of a battery, and a remaining life of a battery. The power supply control unit 80 controls the DC-DC converter based on the detection results and an instruction of the system control unit 50, and thus, supplies each of components including the recording medium 200 with a desirable voltage for a desirable period. The power supply unit 30 includes a primary battery, such as an alkaline cell and a lithium battery, a secondary battery, such as a nickel-cadmium (NiCd) battery, a nickel-metal hydrate (NiMH) battery, and a lithium-ion (Li) battery, or an alternating current (AC) adapter.

The recording medium I/F 18 is an interface with the recording medium 200, such as a memory card and a hard disk. The recording medium 200 is a medium, such as a memory card, for recording a captured image, and is configured of a semiconductor memory or a magnetic disk.

The communication unit 54 connects to an external device by wire or wirelessly, and transmits and receives video signals and audio signals. The communication unit 54 can also connect to a wireless local area network (LAN) and the Internet. The communication unit 54 can communicate with an external device using Bluetooth® or Bluetooth® Low Energy. The communication unit 54 can transmit images (including a live view image) captured by the imaging unit 22 and images recorded in the recording medium 200, and can receive images and other various types of information from an external device.

The orientation detecting unit 55 is an acceleration sensor or a gyroscope sensor, and detects an orientation of the digital camera 100 in the gravity direction. Whether an image captured by the imaging unit 22 is an image captured while the digital camera 100 is held in a lateral position or an image captured while the digital camera 100 is held in a vertical position can be determined based on the orientation detected by the orientation detecting unit 55. The system control unit 50 can add orientation information corresponding to the orientation detected by the orientation detecting unit 55 to image data about the image captured by the imaging unit 22. The system control unit 50 can also turn an image and record the turned image.

The eye approach detection unit 57 is an eye approach detection sensor for detection (approach detection) of the approach (eye approach) and the withdrawal (eye withdrawal) of an eye (an object) 161 to and from the eyepiece unit 16. The system control unit 50 switches between display (a display state) and non-display (a non-display state) of each of the back display unit 28 and the EVF 29, based on an eye-approach state.

To be more specific, in a case where the digital camera 100 is at least in an image capturing standby state and switching of the display destination is automatic switching, the back display unit 28 is set as the display destination and brought into the display state and the EVF 29 is brought into the non-display state while the eye is distant from the eye piece unit 16. The EVF 29 is set as the display destination and brought into the display state and the back display unit 28 is brought into the non-display state while the eye is proximal to the eye piece unit 16 (eye approach state).

The eye approach detection unit 57 is configured of a sensor, such as an infrared proximity sensor, and can detect the approach of some kind of object to the eyepiece unit 16. In a case where an object approaches, infrared light projected from a light projection unit (not illustrated) of the eye approach detection unit 57 is reflected, and the reflected infrared light is received by a light-receiving unit (not illustrated) of the infrared proximity sensor. At what distance from the eyepiece unit 16 the approaching object is located (an eye approach distance) can also be determined based on the amount of the received infrared light.

The eye approach detection unit 57 detects that the eye has approached in a case where an approaching object within a predetermined distance from the eyepiece unit 16 is detected, in a non-eye-approach state (a non-approach state). The eye approach detection unit 57 detects the eye withdrawal in a case where an object currently being detected to be approaching has withdrawn a predetermined distance or more, in an eye approach state (an approach state). A threshold for detecting the eye approach and a threshold for detecting the eye withdrawal can be different from each other, for example, by providing a hysteresis. The detection result is then output to the system control unit 50. The state from the detection of the eye approach to the detection of the eye withdrawal is the eye approach state. The state from the detection of the eye withdrawal to the detection of the eye approach is the non-eye-approach state. The infrared proximity sensor is merely an example, and other types of sensor can be adopted as the eye approach detection unit 57 if the sensor can detect the approach of an eye or object that can be regarded as the eye approach.

The digital camera 100 includes a line-of-sight detection unit 160 between the eyepiece unit 16 and the EVF 29.

The line-of-sight detection unit 160 includes a dichroic mirror 162, an image forming lens 163, a line-of-sight detection sensor 164, a line-of-sight detection circuit 165, and an infrared emitting diode 166. The infrared emitting diode 166 is a light emitting element for detecting a line-of-sight of the user on the screen of the EVF 29, and irradiates the eyeball (eye) 161 of the user looking into the eyepiece unit 16 with infrared light. The infrared light emitted from the infrared emitting diode 166 is reflected by the eyeball (eye) 161, and the reflected infrared light arrives at the dichroic mirror 162. The dichroic mirror 162 reflects only infrared light and allows visible light to pass there through. The reflected infrared light whose optical path is changed is focused on an imaging plane of the line-of-sight detection sensor 164 via the image forming lens 163. The image forming lens 163 is an optical member of a line-of-sight detection optical system. The line-of-sight detection sensor 164 is an imaging device, such as a CCD image sensor.

The line-of-sight detection sensor 164 photoelectrically converts the incident reflected infrared light into an electrical signal, and outputs the electrical signal to the line-of-sight detection circuit 165. The line-of-sight detection circuit 165 detects a line of sight of the user from a movement of the eyeball (eye) 161 of the user, based on the output signal from the line-of-sight detection sensor 164, and outputs the detection result to the system control unit 50. Position information included in the detection result and display coordinates on the display screen of the EVF 29 are associated with each other. This configures a user interface (UI) that makes the user feel as if a screen displayed on the EVF 29 can be operated by a line of sight turned to the eyepiece unit 16. In other words, the eyepiece unit 16 has the function of the operation unit 70. The dichroic mirror 162, the image forming lens 163, the line-of-sight detection sensor 164, the line-of-sight detection circuit 165, and the infrared emitting diode 166 form a configuration example of the line-of-sight detection unit 160. Other configuration can be adopted if the line-of-sight detection unit 160 can detect a viewed position on the display screen of the EVF 29, i.e., the position at which the line of sight of the user is directed on the EVF 29.

A condition for validating or invalidating the detection result from the line-of-sight detection circuit 165 is set. For example, the user can set this condition in menu settings. The system control unit 50 can set validity or invalidity of processing that uses the detection result. Further, the detection result from the line-of-sight detection circuit 165 can be validated in a case where display on the EVF 29 is enabled.

The system control unit 50 can detect the following operations or states on the eyepiece unit 16:
(1) the turning of line of sight that is not turning to the eye piece unit 16, to the eye piece unit 16, that is, start of line-of-sight input;
(2) a state where line of sight is being turning (input) to the eye piece unit 16;
(3) a state where the user is gazing into the eyepiece unit 16;
(4) line of sight being turning toward the eye piece unit 16 is withdrawn, that is, ending the line of sight input; and
(5) a state where no line of sight is turning (input) into the eyepiece unit 16.

The detection result from the line-of-sight detection circuit 165 is notified to the system control unit 50 via an internal bus. The system control unit 50 determines what type of operation (line-of-sight operation) is performed on the eyepiece unit 16, based on the detection result.

In a case where any of the above described states (1), (2), and (3) is determined, the system control unit 50 detects a viewed position on the display screen of the EVF 29 based on the correspondence between the position information included in the detection result from the line-of-sight detection circuit 165 and the display coordinates of the EVF 29. In this way, the system control unit 50 has the function of detecting a viewed position on the display screen, and corresponds to a line-of-sight detection unit.

In a case where the detected viewed position is within a display area, the system control unit 50 measures the time during which the detected viewed position is fixed in the display area, by controlling the system timer 53. A predetermined threshold is set in the system control unit 50. In a case where the time during which the viewed position of the user is fixed within the display area is more than or equal to the predetermined threshold, the system control unit 50 determines that the current state is a state where the user is gazing at the display area. The predetermined threshold can be freely changed. The gaze refers to such a state that the position at which the user's line of sight is directed is continuously detected within a predetermined area such as the display area of a predetermined item. For example, if the detection cycle of the viewed position is 100 ms, the system control unit 50 determines that the user is gazing for 1 second in a case where the viewed position is detected within the predetermined area consecutively ten times.

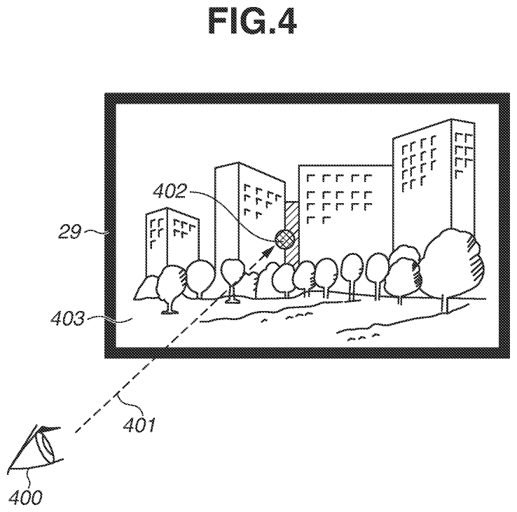

The system control unit 50 displays a predetermined display item on the display screen of the EVF 29, based on a line-of-sight input operation of the user, and executes processing corresponding to this display item. The system control unit 50 corresponds to a display control unit and a control unit. The processing to be executed by the system control unit 50 will be described in detail below with reference to FIG. 4 to FIG. 8.

FIG. 4 is a diagram illustrating a state where the user looks at a point near the center of the display screen of the EVF 29. An eyeball (eye) 400 of the user looks into the eyepiece unit 16 of the digital camera 100. FIG. 4 further illustrates a line-of-sight 401 of a user, and a pointer 402 displayed by the system control unit 50 based on the line-of-sight 401 of the user. The pointer 402 is displayed on the EVF 29. The pointer 402 corresponds to a viewed position of the user. A playback image A 403 is displayed on the EVF 29. The playback image A 403 is displayed in the entire display screen of the EVF 29.

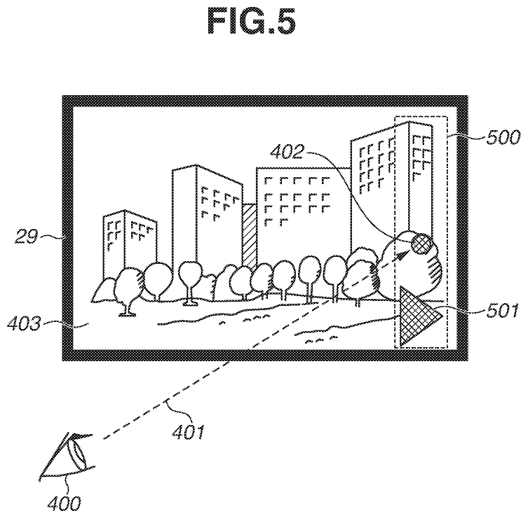

FIG. 5 is a diagram illustrating a state where the user looks at an edge area of the display screen of the EVF 29. FIG. 5 illustrates an edge area 500 of the playback image A 403 displayed on the EVF 29, and a display item 501, which is a predetermined display item. In a case where a viewed position on the edge area 500 is detected, the system control unit 50 displays the display item 501 on the EVF 29.

The display item 501 is displayed at a position different from the detected viewed position (the pointer 402) and in proximity to the detected viewed position (the pointer 402). Thus, the display item is not displayed on the line-of-sight 401 of the user checking the playback image A 403, so that the visibility of the image is not reduced. In a case where the user continuously looks at the same position, the possibility that processing corresponding to the display item 501 is unintentionally executed can be reduced even if the user cannot quickly shift the line of sight thereof away from the position.

The display item 501 is an icon indicated by an arrow pointing in the right direction, and is a next-image-display icon for displaying a playback image that follows the currently displayed playback image. The display item 501 is not limited to the next-image-display icon. For example, a previous-image-display icon can be adopted.

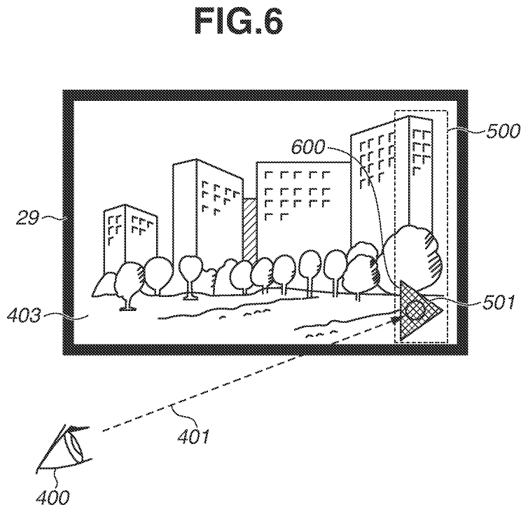

FIG. 6 is a diagram illustrating a state where the user gazes at the display item 501 displayed on the EVF 29 in the state where the display item 501 is displayed as illustrated in FIG. 5. A gaze pointer 600 is illustrated in FIG. 6. In a case where the time that the viewed position is fixed within the display area of the display item 501 is longer than or equal to a first predetermined time, the system control unit 50 determines that the current state is a state where the user is gazing, and changes the display from the pointer 402 to the gaze pointer 600. Subsequently, the system control unit 50 executes the processing corresponding to the display item 501.

As described above, the system control unit 50 executes the processing corresponding to the display item 501, in a case where a first predetermined condition is satisfied in the state where the viewed position on the display item 501 is detected.

According to the present exemplary embodiment, the condition that the time that the display item 501 is gazed at is longer than or equal to the first predetermined time is the first predetermined condition. The first predetermined time is, for example, 0.3 seconds, 0.5 seconds, or 1 second. The first predetermined condition is not limited to the above-described condition. For example, the first predetermined condition can be an interruption of the line-of-sight detection. Alternatively, the first predetermined condition can be satisfied in a case where a touch operation is performed. The processing corresponding to the display item 501 is next-image-display processing, but the processing corresponding to the display item 501 may not be limited to the next-image-display processing.

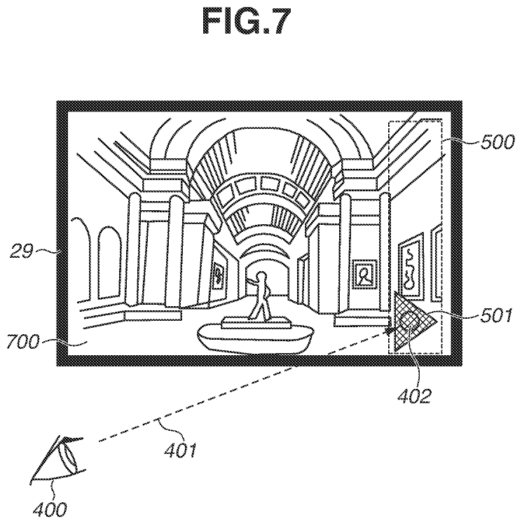

FIG. 7 is a diagram illustrating a state resulting from the execution of the processing corresponding to the display item 501 in the state illustrated in FIG. 6. A playback image B 700 is displayed on the EVF 29. The playback image B 700 is a playback image saved subsequent to the playback image A 403. The playback images are saved in the recording medium 200, but the saving destination of the playback images is not limited to the recording medium 200.

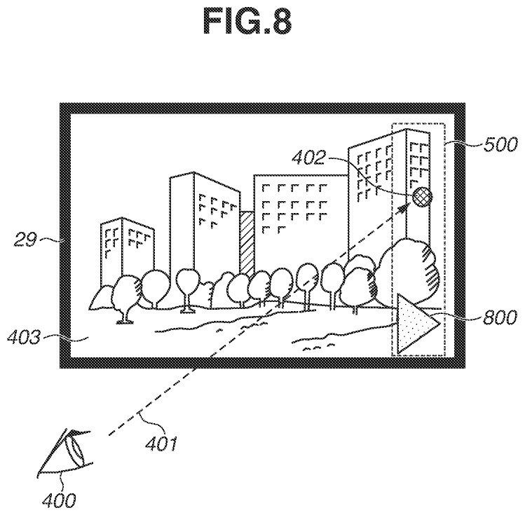

FIG. 8 is a diagram illustrating a state where the user looks at a position different from the display item 501 in the state where the display item 501 is displayed as illustrated in FIG. 5. In a case where the time during which the viewed position is not present within the display area of the display item 501 is longer than or equal to a second predetermined time, the system control unit 50 cancels the display of the display item 501. Although a mark 800 indicates a trace of the deleted display item 501 in FIG. 8, the mark 800, which is the trace of the deleted display item 501, is not displayed on the EVF 29 in practice. The mark 800, which is the trace of the deleted display item 501, is not displayed on the EVF 29, but the mark 800, which is the trace of the deleted display item 501, is not limited to be hidden from the EVF 29.

As described above, the system control unit 50 executes the processing corresponding to the display item 501, in the case where a second predetermined condition is satisfied in the state where the viewed position is not detected on the display item 501.

In the present exemplary embodiment, the condition that the time that the viewed position is not detected on the display item 501 is longer than or equal to the second predetermined time is the second predetermined condition. The second predetermined time is, for example, 0.8 seconds, 1.0 second, or 1.5 seconds. The second predetermined condition is not limited to the above-described condition. For example, the second predetermined condition can be the occurrence of an input operation from a device such as the touch panel 70a.

Next, an example of processing that is executed by the digital camera 100 according to the present exemplary embodiment will be described with reference to the flowchart in FIG. 9. The system control unit 50 controls each functional block of the digital camera 100 by executing the program stored in the nonvolatile memory 56 and implementing each step of the flowchart in FIG. 9.

In the present exemplary embodiment, a description will be provided of an example in which the next-image-display icon serving as the predetermined display item 501 is displayed by an input operation based on a line of sight of the user, and the next-image-display processing serving as the processing corresponding to the display item 501 is executed. This processing starts when the display on the EVF 29 is enabled by power-on of the digital camera 100.

In step S901, when the display on the EVF 29 is enabled by the digital camera 100 being activated, the system control unit 50 starts the display control of the EVF 29, and displays a playback image in the entire display screen of the EVF 29.

In step S902, the system control unit 50 determines whether a viewed position is detected on an edge area of the display screen of the EVF 29 (the line-of-sight input is present). If the system control unit 50 determines that the viewed position is detected on the edge area of the display screen of the EVF 29 (YES in step S902), the processing proceeds to step S903. If the system control unit 50 determines that the viewed position is not detected on the edge area of the display screen of the EVF 29 (the line-of-sight input is not present) (NO in step S902), the processing proceeds to step S925.

In step S903, the system control unit 50 displays the predetermined display item 501 (the next-image-display icon) on the EVF 29. The processing proceeds to step S904. If the detected viewed position is in an edge area along the right side of the display screen, the system control unit 50 displays the display item 501 as an arrow pointing in the right direction, in the right-side edge area of the display screen, but the display is not limited to this example. For example, if the detected viewed position is in an edge area along the left side of the display screen, the system control unit 50 can display the display item as an arrow pointing in the left direction, in the left-side edge area of the display screen. If the user gazes at the display item 501 displayed as the arrow pointing in the right direction, the image is changed to the next image in the sequence. If the user gazes at the item displayed as the arrow pointing in the left direction, the image is changed to the preceding image in the sequence. In this way, it is also possible to execute different functions depending on the direction of the line of sight of the user.

In step S904, the system control unit 50 starts time measurement by an erasure timer for the display item 501. The processing proceeds to step S905. The erasure timer for the display item 501 is a timer that measures the time that the viewed position on the display item 501 is not detected after the display item 501 is displayed.

In step S905, the system control unit 50 determines whether the viewed position on the display item 501 is detected. If the system control unit 50 determines that the viewed position on the display item 501 is detected (YES in step S905), the processing proceeds to step S906. If the system control unit 50 determines that the viewed position on the display item 501 is not detected (NO in step S905), the processing proceeds to step S915.

In step S906, the system control unit 50 stops the time measurement by the erasure timer for the display item 501. The processing proceeds to step S907.

In step S907, the system control unit 50 starts time measurement by a gaze timer for the display item 501. The processing proceeds to step S908. The gaze timer for the display item 501 is a timer that measures the time during which the viewed position on the display item 501 is detected after the display item 501 is displayed.

In step S908, the system control unit 50 determines whether an elapsed time (a gazing time) of the gaze timer for the display item 501 is longer than or equal to the first predetermined time. If the system control unit 50 determines that the elapsed time is longer than or equal to the first predetermined time (YES in step S908), the processing proceeds to step S909. If the system control unit 50 determines that the elapsed time is not longer than or equal to the first predetermined time (NO in step S908), the processing proceeds to step S912. The first predetermined time can be changed depending on a function corresponding to the display item. For example, in a case where the function of deleting an image is assigned to the display item, the first predetermined time can be longer than in a case where the function of displaying the next image is assigned.

In step S909, the system control unit 50 resets the elapsed time of the gaze timer for the display item 501. The processing proceeds to step S910.

In step S910, the system control unit 50 resets the elapsed time of the erasure timer for the display item 501. The processing proceeds to step S911.

In step S911, the system control unit 50 executes the processing (the next-image-display processing) corresponding to the display item 501. The processing proceeds to step S920.

In step S912, the system control unit 50 determines whether the viewed position on the display item 501 is detected. If the system control unit 50 determines that the viewed position on the display item 501 is detected (YES in step S912), the processing proceeds to step S908. If the system control unit 50 determines that the viewed position on the display item 501 is not detected (NO in step S912), the processing proceeds to step S913. In step S913, the system control unit 50 resets the elapsed time of the gaze timer for the display item 501. The processing proceeds to step S914.

In step S914, the system control unit 50 restarts the time measurement by the erasure timer for the display item 501. The processing proceeds to step S905.

In step S915, the system control unit 50 determines whether the elapsed time of the erasure timer for the display item 501 is longer than or equal to the second predetermined time. If the system control unit 50 determines that the elapsed time is longer than or equal to the second predetermined time (YES in step S915), the processing proceeds to step S916. If the system control unit 50 determines that the elapsed time is not longer than or equal to the second predetermined time (NO in step S915), the processing proceeds to step S905.

In step S916, the system control unit 50 resets the elapsed time of the erasure timer for the display item 501. The processing proceeds to step S917.

In step S917, the system control unit 50 cancels the display of the display item 501 displayed on the EVF 29. In a case where the user has not looked at the display item 501 (the next-image-display icon) for a predetermined time or more, it is highly likely that the execution of the processing corresponding to the display item 501 (displaying of the next image) is not desired by the user. In other words, the display item 501 may not be only unnecessary but reduce the visibility of the image. Thus, a reduction in the visibility of the image is prevented by canceling the display of the display item 501 under a certain condition.

In step S918, the system control unit 50 determines whether the viewed position on the edge area of the display screen of the EVF 29 is detected. If the system control unit 50 determines that the viewed position on the edge area of the display screen of the EVF 29 is not detected (NO in step S918), the processing proceeds to step S902. This completes preparation for redisplay of the display item 501.

If the system control unit 50 determines that the viewed position on the edge area of the display screen of the EVF 29 is detected (YES step S918), the operation in step S918 is repeated. In a case where the line of sight of the user remains in the edge area of the display screen of the EVF 29, it is highly likely that the user is checking the displayed image. Thus, the display item 501 is not displayed again until the line of sight of the user shifts away from the edge area. This can prevent a decline in the visibility of the image.

As described above, the system control unit 50 does not display the display item 501 again until a third predetermined condition is satisfied. In the present exemplary embodiment, the condition that the viewed position on the edge area of the image displayed on the EVF 29 is not detected is the third predetermined condition. The third predetermined condition is not limited to such a condition. For example, the third predetermined condition can be such a condition that 0.5 seconds have elapsed since the start of the non-display of the display item 501.

Operations in step S920 to step S924 will be described below, which are performed after the processing corresponding to the display item 501 is executed by the system control unit 50.

In step S920, the system control unit 50 starts time measurement by using a continuous gaze timer for the display item 501. The processing proceeds to step S921. The continuous gaze timer for the display item 501 is a timer that measures the time during which the viewed position on the display item 501 is continuously detected after the processing corresponding to the display item 501 is executed. In other words, the display item 501 stays displayed without being hidden, after the function is executed in step S911.

In step S921, the system control unit 50 determines whether the elapsed time measured by the continuous gaze timer for the display item 501 is longer than or equal to a third predetermined time. If the system control unit 50 determines that the elapsed time is longer than or equal to the third predetermined time (YES in step S921), the processing proceeds to step S924. If the system control unit 50 determines that the elapsed time is not longer than or equal to the third predetermined time (NO in step S921), the processing proceeds to step S922.

In step S924, the system control unit 50 resets the elapsed time measured by the continuous gaze timer for the display item 501. The processing proceeds to step S911.

As described above, the system control unit 50 executes the processing (next-image-display processing) corresponding to the display item 501 again, in the case where a fourth predetermined condition is satisfied in the state where the viewed position on the display item 501 is detected.

In the present exemplary embodiment, the condition that the time during which the user is gazing at the display item 501 is longer than or equal to the third predetermined time is the fourth predetermined condition. The third predetermined time is, for example, 0.2 seconds, 0.3 seconds, or 0.4 seconds. However, the fourth predetermined condition is not limited to such a condition. For example, the fourth predetermined condition may not be satisfied if an interruption of the line-of-sight detection occurs. The fourth predetermined condition can be satisfied in a case where a touch operation is performed. The third predetermined time is shorter than the first predetermined time. The processing (the next-image-display processing) corresponding to the display item 501 can be thereby executed continually and rapidly.

In step S922, the system control unit 50 determines whether the viewed position on the display item 501 is detected. If the system control unit 50 determines that the viewed position on the display item 501 is detected (YES in step S922), the processing proceeds to step S921. If the system control unit 50 determines that the viewed position on the display item 501 is not detected (NO in step S922), the processing proceeds to step S923. In step S923, the system control unit 50 resets the elapsed time of the continuous gaze timer for the display item 501. In this step, the system control unit 50 hides the display item 501. The processing proceeds to step S904.

In step S925, the system control unit 50 determines whether the display on the EVF 29 is enabled. If the system control unit 50 determines that the display on the EVF 29 is enabled (YES in step S925), the processing proceeds to step S902. If the system control unit 50 determines that the display on the EVF 29 is not enabled (NO in step S925), the series of steps of the processing ends.

According to the above-described present exemplary embodiment, the display item 501 is displayed in the case of the presence of the line of sight that is directed to the edge area of the image (the presence of the line-of-sight input), and the display item 501 is not displayed in the case of the absence of the line of sight that is directed to the edge area of the image (the absence of the line-of-sight input). The setting of the first predetermined condition enables the execution of the processing corresponding to the display item 501 in a case where the user is gazing at the displayed display item 501. This can improve the operability of the line-of-sight-based input operation without reducing the visibility of the image. The setting of the second predetermined condition enables the cancelation of the display of the display item 501 in the case of the absence of the line-of-sight that is directed to the display item 501 (the absence of the line-of-sight input) after the display item 501 is displayed. Further, the setting of the third predetermined condition enables the display item 501 to not be redisplayed until the line-of-sight that is directed to the edge area of the image is shifted away therefrom after the display of the display item 501 is canceled. This configuration prevents a decline in the visibility of the image more reliably. The setting of the fourth predetermined condition enables the processing corresponding to the display item 501 to be executed continually and rapidly. This configuration achieves more comfortable operability.

The present disclosure is described in detail above with reference to some exemplary embodiments, but these exemplary embodiments are not seen to be limiting. The above-described exemplary embodiments are merely some exemplary embodiments and can be combined where appropriate.

For example, while the configuration including the EVF 29 serving as the display unit is described, any type of display device that has a configuration using the line-of-sight detection can be used. While a digital camera is described in the exemplary embodiment, the present disclosure is applicable to any type of electronic apparatus that includes the line-of-sight detection unit 160. For example, the present disclosure can be applied to a display apparatus, such as an image viewer, as well as to an audio apparatus, such as a music player. The present disclosure is also applicable to apparatuses including a personal computer, a personal digital assistant (PDA), a mobile phone terminal, a display-equipped printer apparatus, a digital photo frame, a gaming machine, an electronic-book reader, and a wearable device, such as a head-mounted display.

A single hardware device can perform the various above-described control to be performed by the system control unit 50, or a plurality of hardware devices can control the entire apparatus by sharing the processing.

One or more functions of the above-described exemplary embodiments can be implemented by supplying a program to a system or apparatus via a network or storage medium, and causing one or more processors in a computer of the system or apparatus to read out the program and execute the read-out program. The one or more functions can also be implemented by a circuit (e.g., an application-specific integrated circuit (ASIC)).

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Operability of a line-of-sight-based input operation can be improved without a reduction in visibility.

While exemplary embodiments have been described, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-151530, filed Aug. 21, 2019, which is hereby incorporated by reference herein in its entirety.

What is claimed is:

1. An electronic apparatus comprising:
a line-of-sight detection unit configured to detect a viewed position on a display unit;
a display control unit configured to display a predetermined display item on the display unit in a case where the viewed position on an edge area of an image displayed on the display unit is detected; and
a control unit configured to control execution of processing corresponding to the display item in a case where a first predetermined condition is satisfied in a state where the viewed position on the display item is detected.

2. The electronic apparatus according to claim 1, wherein the first predetermined condition is that a time during which the display item is being gazed at is longer than or equal to a first predetermined time.

3. The electronic apparatus according to claim 1, wherein the display control unit displays the display item at a position different from the detected viewed position on the edge area of the image.

4. The electronic apparatus according to claim 1, wherein the display control unit cancels display of the display item in a case where a second predetermined condition is satisfied in a state where the viewed position on the display item is not detected after the display item is displayed.

5. The electronic apparatus according to claim 4, wherein the second predetermined condition is that a time during which the viewed position on the display item is not detected is longer than or equal to a second predetermined time.

6. The electronic apparatus according to claim 4, wherein the display control unit does not redisplay of the display item until a third predetermined condition is satisfied after the display of the display item is canceled.

7. The electronic apparatus according to claim 6, wherein the third predetermined condition is that the viewed position on the edge area of the image is not detected.

8. The electronic apparatus according to claim 6, wherein the control unit re-executes the processing corresponding to the display item in a case where a fourth predetermined condition is satisfied in a state where the viewed position on the display item is detected, after the processing corresponding to the display item is performed.

9. The electronic apparatus according to claim 8, wherein the fourth predetermined condition is that a time during which the display item is being gazed at is longer than or equal to the third predetermined time after the processing corresponding to the display item is performed.

10. The electronic apparatus according to claim 9, wherein the third predetermined time is shorter than the first predetermined time.

11. The electronic apparatus according to claim 1, wherein the display item is a next-image-display icon for displaying an image that follows a currently displayed image.

12. The electronic apparatus according to claim 1, wherein the processing corresponding to the display item is next-image-display processing for displaying an image that follows the currently displayed image.

13. A method for controlling an electronic apparatus, the method comprising:
detecting a viewed position on a display unit;
displaying a predetermined display item on the display unit in a case where the viewed position on an edge area of an image displayed on the display unit is detected; and
controlling execution of processing corresponding to the display item in a case where a first predetermined condition is satisfied in a state where the viewed position on the display item is detected.

14. A computer-readable storage medium storing a program for causing a computer to execute a method for method for controlling an electronic apparatus, the method comprising: detecting a viewed position on a display unit;
displaying a predetermined display item on the display unit in a case where the viewed position on an edge area of an image displayed on the display unit is detected; and
controlling execution of processing corresponding to the display item in a case where a first predetermined condition is satisfied in a state where the viewed position on the display item is detected.
